(19) United States
(12) Patent Application Publication
(10) Pub. No.: US 2024/0026177 A1
(43) Pub. Date: Jan. 25, 2024

(54) INKJET INK, INKJET PRINTING PROCESS AND INK SET FOR FORMING AN IMAGE ON A SUBSTRATE AND AQUEOUS PIGMENT DISPERSION FOR FORMING THE INKJET INK

(71) Applicant: XEIKON MANUFACTURING N.V., LIER (BE)

(72) Inventors: Werner Jozef Johan OP DE BEECK, PUTTE (BE); Lode Erik Dries DEPREZ, LIER (BE); Wouter Jeroom Maria VAN GAENS, DUFFEL (BE); Nils Margaretha Robert DE VOS, PUURS-SINT-AMANDS (BE); Lore WYNS, BOOISCHOT (BE)

(73) Assignee: XEIKON MANUFACTURING N.V., LIER (BE)

(21) Appl. No.: 18/030,142

(22) PCT Filed: Oct. 4, 2021
(86) PCT No.: PCT/EP2021/077306

§ 371 Date: Apr. 4, 2023

(30) Foreign Application Priority Data
Oct. 5, 2020 (NL) 2026619

(51) Int. Cl. C09D 11/326; C09D 11/322

(52) U.S. Cl. CPC C09D 11/326; C09D 11/322

(57) ABSTRACT

Inkjet ink for forming an image on a substrate, the inkjet ink comprising a pigment P, a first block copolymer dispersant D1 for dispersing the pigment P and a second block copolymer dispersant D2 for dispersing the pigment P, and an aqueous carrier; wherein said first block copolymer dispersant D1 is different from said second block copolymer dispersant D2, wherein each block copolymer dispersant D1, D2 comprises an anchoring segment A1, A2 for anchoring to the pigment P, wherein each of the block copolymer dispersant D1, D2 additionally comprises a matrix stabilization segment M for aqueous phase stabilization of the pigment P, wherein the anchoring segment A1 of the first block copolymer dispersant D1 comprises a repeating unit R1 and the anchoring segment A2 of the second block copolymer dispersant D2 comprises a repeating unit R2, wherein the repeating unit R1 is less hydrophobic than the repeating unit R2.

### FIELD OF INVENTION

The field of the invention relates to an inkjet ink, inkjet printing process and ink set of inkjet inks for forming an image on a substrate and aqueous pigment dispersion for forming the inkjet ink. The inkjet printing process for forming an image on a substrate uses an inkjet ink according to the present invention. The ink set of inkjet inks for forming an image on a substrate comprises an inkjet ink according to the present invention. The field of the invention further relates to an aqueous pigment dispersion for forming the inkjet ink according to the invention.

### BACKGROUND

An inkjet printing process for forming an image on a substrate by applying a plurality of inkjet inks on the substrate is generally known. Inkjet inks for industrial printing applications primarily use pigments as colorants, except in the textile industry which often still uses reactive dye based inkjet inks. Pigments are solid materials that also remain as a solid in the inkjet ink carrier, in contrast to dyes which actually dissolve in the carrier medium. The pigment particles are finely dispersed in an ink and are of nanometer scale size. A typical inkjet printing process uses 3 or 4 colors of inkjet inks to create multicolor images. Typical colors are cyan (C), magenta (M), yellow (Y) and black (K). The CMY color inkjet inks are typically made up of organic pigments, wherein some contain a metal atom in a complex, whereas the K inks use organic pigments typically made of carbon black. The pigment powders are commercially not available as nanometer particles, but come as agglomerates and aggregates of pigment particles formed during the synthesis process. The agglomerates and aggregates of pigments need to be made smaller and will typically be brought to the nanometer scale size by grinding, milling, or other techniques to break up the agglomerates and aggregates. The particle size reduction of the pigment powder particles is often carried out in a carrier medium that will be used in a later stage in the ink. Such a process step of making pigment particles smaller is often done at higher pigment concentration than in the final ink and is then referred to as the pigment dispersion.

As discussed above, the pigments are mechanically broken down to sizes of 30-300 nm which are needed to be stabilized by adding dispersing agents (or surfactants) to physically and/or electrostatically prevent the pigments to re-agglomerate. Typically this is a physico-chemical phenomenon as there is no chemical bond between the pigment surface and the dispersing agent, which can be polymeric dispersing agents (e.g. random copolymer, block-copolymers, grafted copolymers) or surfactants.

Sometimes also covalently bound chemicals can be used for pigment particle stabilization in water based inks, but requires mostly an expensive production process.

A known approach for making pigment dispersions is based on random polymerized dispersing agents: they are used in analog inks e.g. for flexographic printing, but also in inkjet inks. Typically, the random polymers are built up of two kinds of monomers, one which is more pigmentophilic and another which is more compatible with the carrier liquid or matrixophilic so to speak. These monomers are randomly spread out in the polymer, so no polymer structure (i.e. monomer sequence) and no number of monomeric repeating units is pre-defined. Hence a number of polymers will have a favorable structure, capable of stabilizing pigment particles in the liquid, but there is a non-active population as well having a “bad” structure for stabilization (e.g. not enough pigment anchors, not close enough to each other pigment anchors, too few matrixophilic groups). These fractions often are not adsorbed or readily desorbed yielding in a non-stable dispersion. Other side effects may occur that are undesired when manufacturing dispersions for inkjet inks. Two of the main problems are that the not-absorbed high molecular weight dispersant molecules are present in the matrix and therefore contribute to a higher dispersion viscosity. Additionally visco-elastic properties of the final ink may be affected negatively. Both effects of increased viscosity and affected visco-elastic properties of the final ink may disturb the drop forming process, such as by increased mist forming.

Another known approach is block copolymer dispersants. Block copolymer dispersants containing hydrophobic and hydrophilic block segments have been disclosed in numerous inkjet ink patents. U.S. Pat. No. 5,859,113 (DU PONT) discloses an AB block copolymer dispersant with a polymeric A segment and a polymeric B segment.

A wide variety of polymeric dispersants, such as block copolymer dispersants, has been proposed, but the dispersion stability of pigments, especially in inkjet, still needs further improvement. For consistent image quality, the inkjet ink requires a dispersion stability capable of dealing with e.g. high temperatures (above 60° C.) during transport or storage of the ink to a customer and changes in the dispersion medium of the inkjet ink during use such as evaporation of water and increasing concentrations of water soluble organic solvents or the addition of functional polymers to improve the adhesion, drying, water or scratch resistance of the ink on a substrate.

In industrial inkjet processes the demands for stability of pigment dispersions usable for inkjet printing is also increasing, in particular at higher jetting frequencies, smaller droplet formation, higher jetting temperatures and/or more demanding single pass printing applications.

All the ink additives (such as surfactants, latexes, polymers, oligomers, (water soluble) organic solvents) can compete with the dispersing agents to interact with the pigment surface and thus negatively influence the pigment dispersion stability. These additives are typically organic in nature (to certain extent even incompatible with the ink matrix), and they will compete for the same organic surface of the pigments, especially pronounced in water based inks. If this occurs inside the printhead, it will lead to removal of the dispersing agent from the surface, lowering or destroying the stability and give rise to irreversibly blocked nozzles resulting in e.g. white lines and severe reduction of image quality or inks containing too large particles that negatively influence the ink flow into the head.

Due to the increasing demands, there is a need to further optimize the ink additives, such as optimization depending on the type of color pigment, to obtain a consistent image quality and a reliable inkjet process.

In addition, for some color pigments it has found to be more difficult to obtain a fine pigment dispersion in a simple way e.g. using a milling process, while enhancing the pigment stability required for an inkjet ink.

A desire remains to formulate block copolymer dispersing agents, which provide a high degree of milling performance (i.e. able to mill down very easy to the desired particle size) for different pigments without the need of additional co-solvents and keeping a high level of stability of the pigment dispersion such that the obtained pigment dispersions provide a broad versatility for formulating final inkjet inks.

As such, there is a need to be able to manufacture such stable pigmented inkjet inks, wherein a dispersion stability of the pigment in the inkjet inks may be enhanced easily for a wider diversity of inkjet inks.

### SUMMARY OF THE INVENTION

According to a first aspect of the invention there is provided an inkjet ink for forming an image on a substrate, the inkjet ink comprising a pigment P, a first block copolymer dispersant D1 for dispersing the pigment P and a second block copolymer dispersant D2 for dispersing the pigment P, and an aqueous carrier; wherein said first block copolymer dispersant D1 is different from said second block copolymer dispersant D2, wherein each block copolymer dispersant D1, D2 comprises an anchoring segment A1, A2 for anchoring to the pigment P, wherein each of the block copolymer dispersant D1, D2 additionally comprises a matrix stabilization segment M for aqueous phase stabilization of the pigment P, wherein the anchoring segment A1 of the first block copolymer dispersant D1 comprises a repeating unit R1 and the anchoring segment A2 of the second block copolymer dispersant D2 comprises a repeating unit R2, wherein the repeating unit R1 is less hydrophobic than the repeating unit R2.

According to another aspect of the invention there is provided an inkjet printing process for forming an image on a substrate by applying a plurality of inkjet inks on the substrate, wherein the plurality of inkjet inks comprise an ink according to the invention.

According to another aspect of the invention there is provided an inkjet ink set comprising a plurality of colored inks, wherein at least one of the inks is an ink according to the invention.

According to another aspect of the invention there is provided an inkjet printer responsive to digital data signals, which has been equipped with an inkjet ink according to the invention or inkjet ink set according to invention.

According to another aspect of the invention there is provided an aqueous pigment dispersion for forming an inkjet ink, the pigment dispersion comprising a pigment P, a first block copolymer dispersant D1 for dispersing the pigment P and a second block copolymer dispersant D2 for dispersing the pigment P, and an aqueous carrier; wherein said first block copolymer dispersant D1 is different from said second block copolymer dispersant D2, wherein each block copolymer dispersant D1, D2 comprises an anchoring segment A1, A2 for anchoring to the pigment P, wherein each of the block copolymer dispersant D1, D2 additionally comprises a matrix stabilization segment M for aqueous phase stabilization of the pigment P, wherein the anchoring segment A1 of the first block copolymer dispersant D1 comprises a repeating unit R1 and the anchoring segment A2 of the second block copolymer dispersant D2 comprises a repeating unit R2, wherein the repeating unit R1 is less hydrophobic than the repeating unit R2; and wherein the aqueous carrier contains water.

### Advantageous Effects of the Invention

It has been found by the inventors that an easy manufacture of a stable pigmented inkjet ink is possible using the combination of the first block copolymer dispersant D1 and the second block copolymer dispersant D2. The repeating unit R1 of the first block copolymer dispersant D1 is less hydrophobic than the repeating unit R2 of second block copolymer dispersant D2. The first block copolymer dispersant D1 has been found to improve the pigment stability required for an inkjet ink and at the same time to enhance an easy manufacturing of a fine pigment dispersion having fine pigment particles in a simple way e.g. using a milling process. The second block copolymer dispersant D2 additionally enhances the pigment stability required for an inkjet ink. The combination of first block copolymer dispersant D1 and second block copolymer dispersant D2 in the pigment dispersion or inkjet ink surprisingly combines these advantages without any adverse effects. Additionally, no or minimal water soluble organic co-solvents are needed to obtain the beneficial fine pigment particles. As such, the pigment dispersion according to the invention can be used in a versatile way to provide inkjet inks having various compositions, such as containing no or various amounts of water soluble organic co-solvents.

The use of two block copolymer dispersants may seem to increase a complexity of the pigment dispersion, but the gain in milling performance and the flexibility in mixing ratio of different block copolymer dispersants achieves the manufacturing of versatile stable pigment dispersions.

Pigments may have surfaces present with different hydrophobicity degrees meaning that one part of the pigment surface can be less hydrophobic than other parts of the pigment surface. It has been found that a very dedicated design/choice of the block copolymer dispersants is necessary to cover the entire pigment surface and thereby achieving a highly stable pigment dispersion.

In addition, the selected block copolymer dispersants D1, D2 for dispersing the pigment P in the ink may prevent that the pigment P re-agglomerate in the resulting inkjet ink, even when various ink additives, such as water soluble organic solvents, which may compete with the dispersants, are added to the inkjet ink.

Moreover use of block copolymer dispersants D1, D2 for dispersing the pigment P may support and enhance the jetting stability in industrial inkjet printing having increasing demands for ink durability and consistent image quality.

(Pigment Dispersion Stability)

A pigment dispersion stability as defined in this application may include a pigment particle grinding characteristic of the pigment dispersion and may include a pigment dispersion stability characteristic when exposed to extreme conditions, such as elevated temperature conditions (relative to room temperature or a normal operation temperature of the ink) and critical aqueous carrier conditions, such as by adding and/or increasing the amount of competing water soluble organic solvents to the carrier and/or other ink additives.

The pigment particle grinding characteristic of the pigment dispersion shows the ability to easily reduce the size of the agglomerates and aggregates of pigments down to nanometer sizes, such as 30-300 nm, which are stabilized by adding the block copolymer dispersant to physically and/or electrostatically prevent the pigments to re-agglomerate.

### EMBODIMENTS OF THE INVENTION

The following exemplary embodiments are described; however the present invention is not limited to these embodiments:

(Block Copolymer Pigment Dispersant)

The combination of block copolymer dispersants D1, D2 has been found to overall improve the pigment stability in the ink. It has been found that selecting block copolymer dispersants D1, D2 with different properties allows dedicated chemical fine-tuning of the dispersing agent in order to optimize the physical interaction of the polymeric dispersing agent to the pigment surface. The balancing act in the design of the copolymer dispersant lies in a pigmentophilic/matrixophilic balance. For water based inks important seems the relative hydrophilic/hydrophobic nature of the polymer. In this way the pigment particle P may be compatibilized with the carrier. Altering the pigmentophilic/matrixophilic balance in a block copolymer can be done in a multitude of ways. The inventors have found that only altering the number of repeating units in the segments may be insufficient, especially when facing pigments with chemically different areas on the pigment particle surface. In order to offer a solution for this problem the inventors have found that it can be highly beneficial to also use a second block copolymer dispersant having a second chemically different type of repeating unit, possible also with a different number of repeating units.

Block copolymer dispersants, unlike random copolymers, have an engineered molecular structure in chemical composition (block-wise incorporated in the polymer), narrow molecular weight distribution, and/or defined block chain lengths of the different constituting blocks or monomers. Block copolymer dispersant can be built up of two or more different monomers, arranged in blocks in the polymer.

A block of the block copolymer of the present invention has a narrow molecular weight distribution, and/or defined block chain length. A block copolymer is defined by a polymer consisting of different blocks wherein each block is substantially equal in size and composition meaning that all polymer molecules have substantially the same composition and length. The same composition means that, in case the block contains one type of repeating unit, that the repeating unit is the same, or, in case the block contains two or more different repeating units, that the number ratio between the respective repeating units is the same.

The fact that the individual blocks, and also the complete polymer, is equal in size can be expressed by the polydispersity D, defined as M_{w}/Mₙ of the individual block or the complete polymer respectively, which is preferably lower than 1.6, more preferably lower than 1.5.

In an exemplary embodiment, the block copolymer dispersant D1, D2 has a polydispersity D lower than 1.6, more preferably lower than 1.5. In a particular embodiment, each of the blocks of the block copolymer dispersant D1, D2 has a polydispersity D lower than 1.6, more preferably lower than 1.5.

Compared to random copolymers that are used commonly as a pigment dispersing agent, the pigmentophilic monomers in block copolymer dispersants can be built as a block of appropriate size and chemistry next to one or more matrixophilic monomer-based blocks of appropriate size and chemistry. This provides options to fine-tune and maximize the interaction between a certain pigment and a block copolymer based dispersing agent. A maximized interaction will yield a strong physico-chemical connection of the dispersing agent with the pigment surface. Since dispersing agents are put on the surface of pigments to prevent re-agglomeration of the pigments, this strong fixation of the dispersing agent to the pigment surface is to inhibit desorption of the polymer from the pigment surface, may enable the creation of highly stable pigment dispersions, especially when used in the final ink, and additionally might provide the advantage of low levels of dispersing agent dissolved in the matrix.

A strong link of dispersing agent with the pigment will also withstand the competing interactions of other ink additives that in water based inks tend to be (at least partially) hydrophobic in nature and thus want to get to the organic pigment surface as well.

In an exemplary embodiment, the block copolymer dispersant D is selected from a diblock copolymer and a triblock copolymer. The matrix stabilization segment may comprise one block formed from one monomer and may further comprise another block formed from another monomer. The anchoring segment may comprise one block formed from one monomer and may further comprise another block formed from another monomer. Thus, the block copolymer dispersant may be a diblock copolymer having two blocks, may be a triblock copolymer having three blocks and may have any other suitable number of blocks larger than three.

The matrix stabilization segment and the anchoring segment of the block copolymer dispersant may be arranged in any order along the block copolymer dispersant.

In an exemplary embodiment, the block copolymer dispersant D1, D2 is a water soluble block copolymer dispersant. A block copolymer is defined as “water soluble” when the block copolymer remains in solution in water at 25° C. with at least 15 wt. % of dry polymer in water during at least a week, preferably remains in solution in water at 25° C. for at least one or more months, more preferably the weight percentage of dissolved dry polymer in water at 25° C. is at least 20 wt. % and most preferably the weight percentage of dissolved dry polymer in water at 25° C. is at least 25 wt. % or above.

A block of a block copolymer dispersant according to the invention may additionally contain an initiator moiety, a terminating moiety, an end group, and/or a linking moiety.

A repeating unit of a block may comprise a substituent. The substituent may optionally be converted to another substituent, thereby modifying the repeating unit, after polymerizing the block or after polymerizing the block copolymer.

In an exemplary embodiment, the block copolymer dispersant D1, D2 is constituted by a linear polymer chain. In another exemplary embodiment, the block copolymer dispersant D1, D2 is at least partially crosslinked, wherein the block copolymer dispersant is attached to or at least partially encapsulates the pigment.

The block dispersant D1 and D2 have each an Mw of 2000 to 20000 g/mol more preferably between 3000 to 12000 g/mol, wherein the ratio between the total number of repeating units of anchoring segment A to the total number of repeating units of matrix stabilizing segment M of D1 and D2 is in the range of 0.5 to 10 more preferably 1 to 5. When the molecular weight of the dispersant is lower than 2000 g/mol the dispersion stability is not maintained and when the molecular weight is higher than 20000 g/mol the viscosity of the dispersion is often too high or the dispersion stability may be affected by dispersant polymer chains anchoring to more than one pigment particle. Polymeric dispersants with a molecular weight above 2000 g/mol also provide the benefit of adhesion to the substrate during the drying process of the ink, even without the addition of binders. Additionally, the use of analogue or digital overprint varnishes can aid in further increasing the properties of the printed image, e.g. mechanical and chemical resistance, hot scuff resistance, and coefficient of friction.

The acid value of the mixture of block copolymer dispersants D1 and D2 is in the range of 50 to 200 mg KOH/g polymer more preferably 60-150 mg KOH/g polymer allowing a good solubility in water. The acid value of the mixture is determined by measuring/calculation the acid value (AV) of the individual block copolymer dispersants D1 and D2 and then calculating the AV of the mixture according the weight ratio of D1 and D2 in the pigment dispersion. The acid value is thus a measure of the weight ratio between the matrix stabilization segment and anchoring segment. At a too high AV, meaning that the contribution of the matrix stabilization segment is too high, the polymer dispersant might temporarily desorb from the pigment surface affecting e.g. the pigment dispersion stability. Another problem of a too high AV is that a water fastness of the ink image on a substrate could be insufficient.

On the other hand, at a too low AV, when the contribution of the anchoring segment is too high, the solubility of the polymer dispersant can be insufficient to provide an efficient milling process, especially when milling with low amounts of a co-solvent or even in absence of a co-solvent. Note that the benefit of a dispersion, which is substantially free of co-solvent is highly preferred as this leaves a free choice of ink components during ink formulation.

Another aspect of acid value is the importance of the value in terms of interaction with primers that are typically used for improving image quality on paper (i.e. uncoated kraft and recycled as well as offset coated media) and film substrates. Analogue and digitally applied primers are used to achieve lower intercolor bleeding, higher optical density, etc. However, primers typically contain cationic components (polymeric or multivalent metal cations) or acidic components, intended to reduce or ‘crash’ the stability of the dispersed pigments. Such primers work best when the acid value of the pigment dispersion is lower than 200 mg KOH/g. To create an optimal bonding between the crashed pigment and the printed substrate such primers often also contain a polymeric binder.

The combination of the proper range of molecular weight and acid value of the block dispersant D1 and D2 is supportive to prepare the pigment dispersion in an easy and cost effective way, e.g. without the use of solvents which have to be removed afterwards. The combination may also support a good interaction with a primer which may be typically used in the ink composition, e.g. for printing on uncoated corrugated board in order to enhance the color intensity on uncoated corrugated board.

In an exemplary embodiment, the anchoring segment A1 is formed using at least one monomer Mn₁, and the anchoring segment A2 is formed using at least one monomer Mn₂, wherein the monomer M₁, M₂ is selected from the group consisting of a methacrylate, an acrylate, and vinyl monomers.

The anchoring segment is an anchoring part for anchoring to the pigment, and wherein the anchoring segment A1 of the block copolymer dispersant D1 is different from the anchoring segment A2 of the block copolymer dispersant D2.

(Anchoring Segment A1)

The first block copolymer dispersant D1 comprises the anchoring segment A1 which comprises the repeating unit R1. The repeating unit R1 of the first block copolymer dispersant D1 is less hydrophobic than the repeating unit R2 of second block copolymer dispersant D2.

(Non-Ionic Less Hydrophobic Repeating Unit R1)

The repeating unit R1 of the anchoring segment A1 is formed using a non-ionic less hydrophobic monomer Mn₁, which may be selected from the group of the group consisting of a methacrylate, an acrylate, and vinyl monomers.

In particular, the repeating unit R1 is a non-ionic repeating unit, meaning that the repeating unit R1 does not comprise an ionic moiety. The non-ionic repeating unit R1 is selected to enhance the anchoring interaction with the pigment P.

Preferably, R1 being less hydrophobic than R2 is based on comparing a Hansen Solubility Parameter value δ(polar+hydrogen) of R1 being higher than a Hansen Solubility Parameter value δ(polar+hydrogen) of R2. The Hansen Solubility Parameters according to the invention are calculated according to Y-MB methodology using HSPiP software version 5.2.03.

The Hansen Solubility Parameters value δ(polar+hydrogen) is the sum of the polar bonding value of the repeating unit and the hydrogen bonding value of the repeating unit and according to the Hansen Solubility Parameters theory this sum is defined as the square root of the sum of the square of the polar bonding value and the square of the hydrogen bonding value of the repeating unit: δ(polar+hydrogen)=√[δ(polar)²+δ(hydrogen)²].

Preferably, the repeating unit R1 has a Hansen Solubility Parameter value δ(polar+hydrogen)_{R1}, being the sum of the polar bonding value of R1 and the hydrogen bonding value of R1, wherein δ(polar+hydrogen)_{R1}>7.2 cal^{1/2} cm^{-3/2}.

The sum of the polar bonding value of R1 and the hydrogen bonding value of R1 is defined as the square root of the sum of the square of the polar bonding value of R1 and the square of the hydrogen bonding value of R1: δ(polar+hydrogen)=√[δ(polar)²+δ(hydrogen)²].

In an exemplary embodiment, the polar bonding value of R1: δ(polar)_{R1}>4.4 cal^{1/2} cm^{-3/2}.

Preferably, the less hydrophobic anchoring monomers Mn₁ of the anchoring segment A1 have a hetero atom in their structure of their substituent, such as dimethylaminoethyl (meth)acrylate (DMAE(M)A), N,N-dimethylacrylamide, acryloyl morpholine (ACMO), N-vinylpyrrolidone (NVP), and vinyl methyl oxazolidinone (VMOX) and 2-(2ethoxyethoxy)ethyl acrylate (EOEOEA). In specific examples, the monomer Mn₁ of the anchoring segment A1 is at least one of tri(ethylene glycol) methyl ether acrylate, hydroxyethyl acrylate, hydroxypropyl acrylate, dimethylaminoethyl acrylate (DMAA), N,N-dimethylacrylamide, acryloyl morpholine (ACMO), N-vinylpyrrolidone (NVP), vinyl methyl oxazolidinone (VMOX),) and 2-(2ethoxyethoxy)ethyl acrylate (EOEOEA), phenoxyethyl methacrylate, methacrylonitrile,

ethylene glycol methyl ether methacrylate, 2-ethoxyethyl methacrylate, di(ethylene glycol) methyl ether methacrylate, tri(ethylene glycol) methyl ether methacrylate, hydroxyethyl methacrylate, hydroxypropyl methacrylate, di(propylene glycol) methyl ether methacrylate, phenoxyethyl acrylate, ethylene glycol methyl ether acrylate, 2-ethoxyethyl acrylate, di(ethylene glycol) methyl ether acrylate, 2-[[(butylamino)carbonyl]oxy]ethyl acrylate, and any mixture thereof.

In preferred examples, the monomer Mn₁ of the anchoring segment A1 is an acrylate or methacrylate and comprises a monoethyleneglycol group or polyethyleneglycol group.

In particular examples, the anchoring segment A1 contains at least two, differing, repeating units, which may be formed by using at least two differing anchoring monomers Mn₁.

In an exemplary embodiment, the anchoring segment A1 of the first block copolymer dispersant D1 has another repeating unit R1′ different from R1. Preferably, the other repeating unit R1′ has a Hansen Solubility Parameter value δ(polar+hydrogen)_{R1}>7.2 cal^{1/2} cm^{-3/2}. In said embodiment R1′ provides additional beneficial contribution to a grinding performance of block copolymer dispersant D1.

(Anchoring Segment A2)

The second block copolymer dispersant D2 comprises the anchoring segment A2 which comprises the repeating unit R2. The repeating unit R1 of the first block copolymer dispersant D1 is less hydrophobic than the repeating unit R2 of second block copolymer dispersant D2.

(Hydrophobic Repeating Unit R2)

The repeating unit R2 of the anchoring segment A2 is formed using a hydrophobic monomer Mn₂, which may be selected from the group consisting of a methacrylate, an acrylate, and vinyl monomers.

In an exemplary embodiment, the repeating unit R2 has a Hansen Solubility Parameter value δ(polar+hydrogen)_{R2}, being the sum of the polar bonding value of R2 and the hydrogen bonding value of R2, wherein δ(polar+hydrogen)_{R2}<7.2 cal^{1/2} cm^{-3/2}. The repeating unit R2 is more hydrophobic than repeating unit R1, which corresponds to a lower sum of the polar bonding value and the hydrogen bonding value of R2.

In an exemplary embodiment, the polar bonding value of R2 δ(polar)_{R2}<4.4 cal^{1/2} cm^{-3/2}. The repeating unit R2 is more hydrophobic than repeating unit R1, which corresponds to a lower polar bonding value of R2.

In an exemplary embodiment, the monomer Mn₂ of the anchoring segment A2 comprises an alkyl, alkenyl or aryl group.

In specific examples, the monomer Mn₂ of the anchoring segment A2 is at least one of benzyl methacrylate, butyl methacrylate, methyl methacrylate, ethyl methacrylate, propyl methacrylate, hexyl methacrylate, 2-ethylhexyl methacrylate, octyl methacrylate, lauryl methacrylate, stearyl methacrylate, p-tolyl methacrylate, sorbyl methacrylate, cyclohexyl methacrylate, benzyl acrylate, butyl acrylate, methyl acrylate, ethyl acrylate, propyl acrylate, hexyl acrylate, 2-ethylhexyl acrylate, octyl acrylate, lauryl acrylate, stearyl acrylate, p-tolyl acrylate, sorbyl acrylate, cyclohexyl acrylate and any mixture thereof.

In particular examples, the anchoring segment A2 contains at least two, differing, repeating units, which may be formed by using at least two differing anchoring monomers Mn₂.

In an exemplary embodiment, the anchoring segment A2 of the second block copolymer dispersant D2 has another repeating unit R2′ different from R2. Preferably, the other repeating unit R2′ has a Hansen Solubility Parameter value δ(polar+hydrogen)_{R2}<7.2 cal^{1/2} cm^{-3/2}. In said embodiment R2′ provides additional beneficial contribution to a pigment dispersion stability effect of block copolymer dispersant D2.

(Relation of Repeating unit R1 and Repeating unit R2 in the anchoring segments A1, A2) In an exemplary embodiment, the repeating units R1, R2 of the anchoring segment A1, A2 do not have an ionic group. As such, the anchoring segments A1, A2 do substantially not dissolve in the aqueous carrier phase.

In an exemplary embodiment, the anchoring segment A1 has a number of repeating units n1 and wherein the repeating units R1 are at least 50 number-% of the total number of repeating units n1, preferably at least 80 number-% of the total number of repeating units n1.

In an exemplary embodiment, the anchoring segment A2 has a number of repeating units n2 and wherein the repeating units R2 are at least 50 number-% of the total number of repeating units n2, preferably at least 80 number-% of the total number of repeating units n2.

(Matrix Stabilisation Segment M)

Each of the block copolymer dispersants D1, D2 additionally comprises a matrix stabilization segment M for aqueous phase stabilization of the pigment P.

In an exemplary embodiment, the matrix stabilization segment M is formed using at least one monomer Mn₃. Preferably, the at least one monomer Mn₃ is a monomer for obtaining an ionic hydrophilic repeating unit for aqueous phase stabilization of the pigment. The ionic hydrophilic repeating unit provides solubility of the matrix stabilization segment M in the aqueous carrier phase. The ionic hydrophilic repeating unit optionally contains a neutralized acid group, neutralized basic group, such as a protonated amino group, or other ionic functionalities such as a quaternary ammonium group.

In case two different monomers Mn₃ are used to form the matrix stabilization segment M, the matrix stabilization segment M has a first repeating unit and a second repeating unit, each formed by a respective, different, monomer Mn₃. In that case, the number of first repeating units and the number of second repeating units of segment M together sum up to the total number n of repeating units of segment M, i.e. the matrix stabilization part of the first block.

In particular, the at least one ionic hydrophilic repeating unit R3 of the matrix stabilization segment M comprises an ionic moiety.

Additionally, the matrix stabilization segment M may comprise other non-ionic repeating units additionally to the ionic hydrophilic repeating units. In an exemplary embodiment, the matrix stabilization segment M may comprise ionic hydrophilic repeating units and non-ionic matrix stabilizing repeating units contain (poly)glycol functionalities. The ionic hydrophilic repeating units and non-ionic repeating units of the matrix stabilization segment M cooperatively contribute to the water solubility of the polymer.

(Ionic Repeating Unit R3)

In specific examples, the matrix stabilization segment M is formed using at least one monomer Mn₃ for obtaining an ionic hydrophilic repeating unit R3, respectively. The ionic hydrophilic repeating unit R3 preferably containing a neutralized acid group, neutralized basic group or other ionic functionalities such as a quaternary ammonium group.

The ionic hydrophilic repeating unit R3 provides solubility of the matrix stabilization segment M in the aqueous carrier phase.

In specific examples, the matrix stabilization segment M is formed using at least one monomer Mn₃ which is selected from the group consisting of methacrylic acid, acrylic acid, maleic acid, maleic acid monoester, itaconic acid, itaconic acid monoester, crotonic acid, crotonic acid monoester, N,N-dimethylaminoethyl methacrylate, N,N-diethylaminoethyl methacrylate, N,N-dimethylaminoethyl acrylate, N,N-diethylaminoethyl acrylate, t-butylaminoethyl methacrylate, t-butylaminoethyl acrylate, and mixtures thereof.

In case the matrix stabilizing segment contains hydrophilic repeating units with acid functionality, a considerable part of the acid groups needs to be neutralized with a neutralizing agent to provide solubility and dispersion stability, preferably all acids are neutralized by setting the pH level to 7.5 and most preferably the pH is set to 8.5 or above. In case the matrix stabilizing segment contains hydrophilic repeating units with basic functionality a considerable part of the basic groups, such as protonated amino groups, are neutralized to provide solubility and dispersion stability, preferably all basic groups are neutralized by setting the pH level to 6.5 and most preferably the pH is set to 5.5 or below.

The choice of the neutralizing agent and thus the corresponding used salt counter ion of the repeating unit R3 determines the, modified, repeating unit R3 in such way that this has to be considered as a different chemical structure.

Possible neutralization agents for acidic groups are tertiary amines such as trimethylamine and triethylamine, triethanolamine, ammonia, 2-dimethylamino ethanol, 2 amino-2 methyl 1 propanol, 2 (2-amino-ethylamino) ethanol, 2 amino-2methyl 1 propanol, sodium hydroxide, potassium hydroxide, and the like.

Possible neutralization agents for basic groups, such as amino groups, include inorganic acids such as hydrochloric acid and sulfuric acid; and organic acids such as acetic acid, citric acid, maleic acid, propionic acid, lactic acid, succinic acid and glycolic acid. The present invention is not limited to those exemplified ones.

The selection of the neutralizing agent and corresponding salt counter ion of the repeating unit R3 may have an effect on pigment dispersion stability; including an effect on a pigment particle grinding characteristic and speed of the pigment dispersion and/or including an effect on a pigment dispersion stability characteristic when exposed to extreme conditions. The selection of the neutralizing agent, pH value and corresponding salt counter ion can also influence the behaviour of the final ink, e.g. the drying speed, open time, first drop reliability and the jetting stability.

(Pigment)

For water based inks the pigment surface has in general a more hydrophobic nature than the bulk liquid. Therefore hydrophobic anchoring monomers like alkyl acrylates and aryl acrylates, like benzylacrylates, can be used. However some pigments have been found to have additional pigment surfaces being less hydrophobic and these pigments have been found more difficult to realize a good milling performance and dispersion stability with one block dispersant only.

The differences in pigment surface may be shown by chemical analysis or by the synthesis procedure of the pigment or can experimentally be demonstrated by HSPIP/Hansen Solubility methodology. In this methodology the solubility of the substance may be evaluated in different solvents and as a result the solubility/compatibility may be expressed as a hydrogen force, a dipole force and Vanderwaals/dispersive force. Pigments which may have clearly differing pigment surfaces are a.o. PR122, PBk7, PB15.3, PY74 and PY155.

The anchoring segment A1 of the block copolymer dispersant D1 and the anchoring segment A2 of the block copolymer dispersant D2 thus contains different repeating units that may be selected for different anchoring sites on the pigment surface. For example, in case of a crystalline structure of the pigment, surfaces with different chemical nature may exist and may need different anchoring chemistry to achieving higher pigment dispersion stability.

In exemplary embodiments, the pigment P is a color pigment selected for adjusting a color of the ink.

In exemplary embodiments, the pigment P is an organic pigment, optionally comprising a metal atom complexed with an organic component of the organic pigment.

In exemplary embodiments, the pigment P is an inorganic pigment optionally comprising a metal oxide.

In a particular exemplary embodiment, the magenta pigment is a quinacridone pigment selected from Pigment Red 122, Pigment Violet 19 and Pigment Red 202, or the magenta pigment is Pigment Red 57:1, and/or wherein the cyan pigment is Pigment Blue 15:3, Pigment blue 15.4, pigment blue 15.6 and/or wherein the yellow pigment is selected from Pigment Yellow 155 and Pigment Yellow 74, and pigment yellow 180 and/or wherein the black pigment is a carbon black, preferably Pigment Black 7.

(Aqueous Pigment Dispersion)

Preferably, the amount of water in the aqueous carrier is at least 50 wt.-%, preferably at least 80 wt.-%, more preferably at least 95 wt.-%, of the total weight of the aqueous carrier.

In specific examples, the aqueous carrier contains a total amount of water soluble organic solvent, which is less than 20 wt %, preferably less than 10 wt %, in particular preferably less than 5 wt %, of the total weight of the aqueous carrier. Preferably, the aqueous carrier contains substantially no water soluble organic solvent.

The relatively high amount of water in the aqueous carrier, and/or relatively low amount of water soluble organic solvent or no water soluble organic solvent, enhances a versatile easy use of manufacturing inkjet inks derived from the Aqueous Pigment Dispersion.

In an exemplary embodiment, the amount of pigment P in the pigment dispersion is in the range of 10-60 wt-% based on weight of the pigment dispersion. The pigment dispersion may be a concentrated dispersion of pigment P compared to an inkjet ink derived from the pigment dispersion. In general, an amount of a colored pigment P in the inkjet ink may be in the range of 0.5-10 wt-% based on weight of the inkjet ink. In case of an inorganic, preferably white, pigment the amount of pigment P in the pigment dispersion is in the range of 40-80 wt-% based on weight of the pigment dispersion and 10-50 wt-% in the final inkjet ink.

In an exemplary embodiment, the weight ratio between the block copolymer dispersant D1 and the block copolymer dispersant D2 is between 0.1 and 10, preferably between 0.2 and 5.

In an exemplary embodiment, the weight ratio between the pigment P and the sum of the block copolymer dispersant D1 and the block copolymer dispersant D2 is between 0.2 and 10.0, preferably between 0.4 and 5.0.

In an exemplary embodiment, the weight ratio between the pigment P and the block copolymer dispersant D1 is between 0.05 and 10.0, preferably between 0.1 and 5.0.

In an exemplary embodiment, the weight ratio between the pigment P and the block copolymer dispersant D2 is between 0.05 and 10.0, preferably between 0.1 and 5.0.

(Method for Preparing Aqueous Pigment Dispersion)

Preferably, the Aqueous Pigment Dispersion is prepared without the use of water soluble organic solvents or other organic solvents.

The pigment dispersion is prepared by mixing the raw materials in the appropriate ratios. The pigment concentration is typically between 10 and 60 wt-% and the weight ratio pigment/block dispersing agents is typically 0.1 to 10. As block dispersing agents a combination of block copolymer dispersant D1 and the block copolymer dispersant D2 according to the invention is used.

The weight ratio between the block copolymer dispersant D1 and the block copolymer dispersant D2 is between 0.1 and 10, preferably between 0.2 and 5.

Other ingredients beside the pigment, dispersing agent and water can be added to improve the pigment dispersion process like wetting agents (typically Mw<1000 g/mol) and the like.

Preferably, no or only a limited amount of water soluble co-solvents (like alkyl ethers or glycols) are used for preparing the Aqueous Pigment Dispersion.

It is beneficial to perform a very good mixing of the raw materials by known methods in the art like cowls mixers, dissolvers, to obtain a very good premix before starting the final dispersion step. No particular limitation is imposed on the dispersion method. Examples of dispersion methods are paint shakers, horizontal and vertical bead mills and high pressure homogenizers. In order to assure a very good anchoring of the dispersing agent on the pigment surface and or a very good electro steric stabilization it can be beneficial to mill at elevated temperature (40 to 80° C.) or to perform a heat treatment at 40 to 80° C. after the milling step for a certain time. This heat treatment can be carried out static or dynamic (i.e. some kind of agitation/stirring of the dispersion during the heat treatment)

After milling is completed, the milling media is separated from the milled particulate using conventional separation techniques, such as by filtration, sieving through a mesh screen, and the like. Often the sieve is built into the mill, e.g. for a bead mill.

Preferably the block copolymer dispersants are dissolved in an aqueous medium before making the pre-dispersion. The dissolved polymer is achieved by mixing the dried block copolymer with water and if required additional neutralization agent for at least 2 h at room temperature. Stirring and/or increasing the temperature up to 60° C. may be used to accelerate the dissolution process.

(Aqueous Pigmented Inkjet Ink)

Any amount of additional water and water soluble organic co-solvents may be added to the pigment dispersion to form inkjets according to the invention. Any other suitable additives, such as surfactants, binders, dispersing aids, thickeners, pH-adjusting agents, etc., may be added to the pigment dispersion to form inkjet inks according to the invention.

In an exemplary embodiment, the ink is an aqueous ink having an aqueous carrier. The aqueous carrier is liquid at room temperature. The aqueous carrier comprises water and optionally water soluble organic co-solvent or co-solvents for carrying or suspending the pigment P including the block copolymer dispersants D1, D2.

In an exemplary embodiment, the amount of pigment in the ink is at least 0.5 wt-%, preferably at least 1.0 wt-%, relative to the total weight of the ink, wherein preferably the ink has a viscosity of at most 20 mPa·s at 25° C.

In exemplary embodiments, the viscosity of the inkjet inks is between 4 and 30 mPa·s at 25° C., preferably between 4 and 20 mPa·s at 25° C.

In exemplary embodiments, the static surface tension of the inkjet inks is between 17 and 35 mN/m.

In particular, the ink may contain at least one binder resin for improving at least one of adhesion to a substrate, drying, water or scratch resistance of the ink on a substrate. Said binder resin may be a water soluble resin or may be provided as resin microparticles. The resin microparticles are dispersed in the inkjet ink as emulsions or lattices.

The inkjet ink containing binder may be used for enhanced adhesion of the pigment to the substrate while maintaining a high pigment stability. The pigment dispersion of the inkjet ink according to the invention has been found to maintain the high stability when used in combination with said at least one binder resin.

(Water Soluble Organic Solvent)

In an exemplary embodiment, the water soluble organic solvent comprises at least one of a polyol compound, an a glycol ether compound, such as a (poly)ethyleneglycol ether or (poly)propyleneglycol ether compound. A polyol compound in the context of this application is the same as a polyhydric alcohol, i.e. having at least two alcohol groups like for example glycerol or propyleneglycol. In a particular exemplary embodiment, the water soluble glycol ether compound is a glycol monobutyl ether.

A water soluble organic solvent may be selected being a penetrant for improving permeability (wettability) of the ink into the substrate. A penetrant supports adjusting a dot diameter on the substrate and/or improves adhesion of the pigment to the substrate. Particular suitable penetrants have surface tension active properties thereby lowering the surface tension of the ink.

Exemplary penetrants include alkanediols and glycol ethers. It has been found by the inventors that water soluble organic solvents having penetrant properties tend to compete with dispersants, which stabilize the pigment.

An exemplary penetrant is a glycol monobutyl ether, such as diethylene glycol monobutyl ether or ethylene glycol monobutyl ether. It should be noted that some penetrants like diethylene glycol monobutyl ether, ethylene glycol monobutyl ether, dipropyleneglycol monomethyl ether, ethylene glycol isopropyl ether, 1,2-hexanediol have surface tension active properties thereby lowering the surface tension of the ink.

In an exemplary embodiment, the weight-concentration of the at least one water soluble organic solvent, in the ink is in the range of 5 wt-%-40 wt-%, preferably in the range of 5 wt-%-30 wt-%, based on the total weight of the ink.

In a particular embodiment, the weight-concentration of the at least one penetrant in the ink is in the range of 1 wt-%-15 wt-%, preferably in the range of 2 wt-%-10 wt-%, based on the total weight of the ink.

(Aqueous Pigmented Inkjet Ink Set)

In specific examples, the inkjet inks of the ink set comprise a cyan ink comprising a cyan pigment, a magenta ink comprising a magenta pigment, a yellow ink comprising a yellow pigment and a black ink comprising a black pigment. The ink set may include any other colored pigmented ink and/or non-colored pigmented ink. The ink set may further include one or more non-pigmented inks.

(Inkjet Printing Process)

In an exemplary embodiment, the inkjet printing process comprising jetting droplets of each inkjet ink on the substrate to form a color image on the substrate.

In a particular exemplary embodiment, the droplets are jetted by using an inkjet printhead.

In an exemplary embodiment, the inkjet process comprises forming the image on a finished corrugated board, a corrugated liner, label substrate like paper and filmic labels or flexible packaging substrate in a single pass at speeds of at least 30 m/min, preferably at least 50 m/min.

### DETAILED DESCRIPTION

As used herein, the term “dispersion” means a two-phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles. For pigments, the dispersants can be polymeric dispersants, and the dispersion comprising the dispersants and pigments is usually prepared using dispersing equipment.

As used herein, the term “aqueous” refers to water or a mixture of water and at least one water soluble, or partially water soluble, organic solvent (co-solvent). As used herein, the term “water based ink” has the same meaning as the term “aqueous ink”.

As used herein, the term “substantially” means being of considerable degree, almost all.

As used herein, the term “ink set” means a combination of inkjet inks used as a kit of parts for printing an image on a substrate by applying the inkjet inks on the substrate according to the present invention. In particular, the ink set is a combination of inkjet inks which may be used together in the same printing process to form a color image on the substrate.

The materials, methods, and examples herein are illustrative, and are not intended to be limiting. The term “urethane” as used herein, must be understood to also include isomers of urethane, such as C—O—(C═O)—N<->C—O—(C—OH)═N isomers.

Aqueous Inks

The use of a colorant in inks is the most essential form of a water based ink. However in order to prevent drying of the ink at the nozzles, aqueous inks used in inkjet printing methods typically also contain a water soluble organic solvent having a high boiling point and favorable solubility in water. This type of solvent may also be regarded as a humectant in the aqueous ink.

Aqueous inks used in inkjet printing methods may typically also contain a water soluble organic solvent being a penetrant for improving permeability (wettability) of the ink into the substrate. A penetrant supports adjusting a dot diameter on the substrate and/or improves adhesion of the pigment to the substrate. Particular suitable penetrants have surface tension active properties thereby lowering the surface tension of the ink. Further, to enable a minimal amount of wetting and spreading of water based inks in the printhead, on the substrate, etc. the aqueous inks used in inkjet printing methods typically also contain one or more surfactants.

Finally, the aqueous ink composition may also contain various types of additives such as anti-foaming agents, thickeners, binders and preservatives as required. Adding these types of additives to the aqueous ink composition enables the composition to be used more favorably as an inkjet ink.

Pigment

A pigment is preferably used from the viewpoints of offering excellent water resistance, light resistance, weather resistance and gas resistance or the like. Examples of pigments that may be used in the present invention include conventional organic pigments and inorganic pigments. The pigment may be chosen from those disclosed by HERBST, W., et al. Industrial Organic Pigments, Production, Properties, Applications. 2nd edition. vch, 1997.

The pigment particles in the pigmented inkjet ink should be sufficiently small to permit free flow of the ink through the inkjet printing device, especially at the ejecting nozzles. It is also desirable to use small particles for maximum color strength and to slow down sedimentation.

The average particle size of the pigment in the pigmented inkjet ink should be between 5 nm and 1 μm, particularly preferably between 5 nm and 500 nm and most preferably between 30 nm and 300 nm. Larger pigment particle sizes may be used as long as the objectives of the present invention are achieved.

The pigment is used in the pigmented inkjet ink in an amount of 0.1 to 30 wt-%, preferably 1 to 10 wt-% based on the total weight of the pigmented inkjet ink.

Examples of cyan pigments that can be used in the present invention include C.I. Pigment Blue 1, 2, 3, 15:3, 15:4, 15:6, 16 and 22, and C.I. Vat Blue 4 and 6. These cyan pigments may be used individually, or a combination of two or more pigments may be used.

Examples of magenta pigments that can be used in the present invention include C.1. Pigment Red 5, 7, 12, 22, 23, 31, 48 (Ca), 48 (Mn), 49, 52, 53, 57 (Ca), 57:1, 112 and 122; Quinacridone solid solutions 146, 147, 150, 185, 238, 242, 254, 255, 266 and 269, and C.I. Pigment Violet 19, 23, 29, 30, 37, 40, 43 and 50. Quinacridone mixed-crystal pigments can also be used.

Examples of yellow pigments that can be used in the present invention include C.I. Pigment Yellow 10, 11, 12, 13, 14, 17, 20, 24, 74, 83, 86, 93, 94, 95, 109, 110, 117, 120, 125, 128, 137, 138, 139, 147, 148, 150, 151, 154, 166, 168, 180, 185 and 213.

Other organic pigments can be used to enhance the color gamut like C.I. Pigment Green 36, and 7, Pigment Violet 23Pigment Orange 34 and 64.

Examples of black pigments that can be used in the present invention include organic pigments such as aniline black, Lumogen black and azomethine black, and inorganic pigments such as carbon black and iron oxide. Further, a plurality of color pigments such as the aforementioned yellow pigments, magenta pigments and cyan pigments may be mixed together and used as a black pigment.

There are no particular limitations on the inorganic pigments that may be used in the present invention. Examples of inorganic pigments may also include different metal oxides.

Additionally, the inorganic pigment can include a white pigment such as titanium dioxide (anatase, brookite and rutile) which is for example commercially available from KRONOS (e.g. grade 2044, 2047) or as metal oxide coated titanium dioxides (e.g. R700 E.I. DuPont de Nemours), or other inorganic pigments such as zinc oxide and iron oxide.

Examples of carbon black pigments that can be used in the present invention include carbon blacks produced using the furnace method or the channel method.

Examples of commercial products are listed below, and any of these products can be used favorably.

Specific examples of carbon black include No. 33, 40, 45, 52, 900, 2200B, 2300, MA7, MA8 and MCF88 (all manufactured by Mitsubishi Chemical Corporation), RAVEN 1255 (manufactured by Columbian Chemicals Co., Inc.), REGAL 330R, 400R and 660R, and MOGUL L (all manufactured by Cabot Corporation), and Nipex 1601Q, Nipex 1701Q, Nipex 75, Printex 85, Printex 95, Printex 90, Printex 35 and Printex U (all manufactured by Orion Engineered Carbons LLC).

In this embodiment of the present invention, the pigment is not limited to the pigments described above, and other special colors such as orange pigments and green pigments can also be used. Further, a plurality of pigments may be combined. Moreover, in another embodiment, the aqueous ink composition of this embodiment of the present invention may be combined with a clear ink containing no pigment and used as an ink set.

Any other pigment and/or dye can be used that is useful in modifying the color of the ink.

Surfactant

The inkjet ink according to the present invention may contain at least one surfactant. The surfactant(s) can be anionic, cationic, non-ionic, or zwitter-ionic and are usually added in a total quantity less than 6 wt-% based on the total weight of the pigmented inkjet ink and particularly in a total less than 4 wt-% based on the total weight of the pigmented inkjet ink.

Suitable surfactants for the inkjet ink according to the present invention include silicon-based, acrylic-based and fluorine-based surfactants, fatty acid salts, ester salts of a higher alcohol, alkylbenzene sulphonate salts, sulphosuccinate ester salts and phosphate ester salts of a higher alcohol, ethylene oxide adducts of a higher alcohol, ethylene oxide adducts of an alkylphenol, ethylene oxide adducts of a polyhydric alcohol fatty acid ester, and acetylene glycol and ethylene oxide adducts thereof. Commercial examples include Byk-348, Byk-347, Byk-3450, Dynwet 800 (Byk Chemie Gmbh); Surfynol 104, Surfynol 465, Metolat 364, Dynol 800, Dynol 960, (Evonik Industries), KF-640, KF-642 (Shin-Etsu); ID-40, ID-70 (Sanyo Chemical industries); Olfine E1004, Olfine E1010, Olfine EXP4300, Silface SAG503 all of Nisshin Chemical; etc. and combinations thereof.

Water Soluble Organic Solvent

The type of water soluble, organic, solvent is not particularly limited insofar as the effects of the present invention can be obtained. It is preferable that the organic solvent is water soluble from the viewpoint of increasing the compatibility with respect to water. Examples of the water soluble organic solvent include alcohols, polyhydric alcohols, amines, amides, glycol ethers, 1,2-alkanediols and the like. Only one type of the organic solvent may be used, or two or more types thereof may be used.

Examples of polyhydric alcohols described above include ethylene glycol, diethylene glycol, triethylene glycol, tetraethylene glycol, polyethylene glycol having the number of ethylene oxide groups of greater than or equal to 5, propylene glycol, dipropylene glycol, tripropylene glycol, polypropylene glycol having the number of propylene oxide groups of greater than or equal to 4, butylene glycol, hexanediol, pentanediol, glycerin, hexanetriol, thiodiglycol, and the like.

Examples of amines described above include ethanol amine, diethanol amine, triethanol amine, N-methyl diethanol amine, N-ethyl diethanol amine, morpholine, N-ethyl morpholine, ethylene diamine, diethylene diamine, triethylene tetramine, tetraethylene pentamine, polyethylene imine, pentamethyl diethylene triamine, tetramethyl propylene diamine, and the like.

Examples of amides described above include formamide, N,N-dimethyl formamide, N,N-dimethyl acetamide, pyrolidone, urea and the like.

Examples of glycol ethers described above include ethylene glycol monoethyl ether, ethylene glycol monobutyl ether, diethylene glycol monoethyl ether, diethylene glycol monobutyl ether, triethylene glycol monobutyl ether, propylene glycol monopropyl ether, dipropylene glycol monomethyl ether, tripropylene glycol monomethyl ether, and the like.

Examples of 1,2-alkanediols include 1,2-propanediol 1,2-butanediol, 1,2-pentanediol, 1,2-hexanediol, 1,2-heptanediol, and the like.

Among them, in a case where the water soluble organic solvent is polyhydric alcohols, blur at the time of performing printing at a high velocity can be preferably suppressed. Preferred examples of polyhydric alcohols include ethylene glycol, diethylene glycol, triethylene glycol, tetraethylene glycol, propylene glycol, dipropylene glycol, tripropylene glycol, and the like.

Water soluble organic solvents may be selected being a penetrant for improving permeability (wettability) of the ink into the substrate. A penetrant supports adjusting a dot diameter on the substrate and/or improves adhesion of the pigment to the substrate. Particular suitable penetrants include alkanediols and glycol ethers.

An exemplary penetrant is a glycol monobutyl ether, such as diethylene glycol monobutyl ether and ethylene glycol monobutyl ether. It should be noted that some penetrants like diethylene glycol monobutyl ether, ethylene glycol monobutyl ether, ethylene glycol isopropylether, 1,2-hexanediol also have surface tension active properties thereby lowering the surface tension of the ink.

Binder Resin

In one embodiment, the aqueous ink composition of the present invention preferably also contains a binder resin (functional polymer). Known binder resins for aqueous ink compositions include water soluble resins and resin microparticles (emulsions/latexes). Examples of types of resins that can be used as the resin microparticles include acrylic-based, styrene/acrylic-based, urethane-based, styrene/butadiene-based, vinyl chloride-based, vinylacetate-based (possibly partially or fully hydrolysed), polyester-based, and polyolefin-based resins.

These additional binder resins may aid in achieving a stable jetting process, adhesion of the ink to the substrate, chemical and/or mechanical resistance of the final ink layer, or improve image quality.

Biocides

Suitable biocides for the pigmented inkjet ink of the present invention include sodium dehydroacetate, 2-phenoxyethanol, sodium benzoate, sodium pyridinethion-1-oxide, ethyl p-hydroxybenzoate, 2-methyl-1,2-thiazol-3-one and 1,2-benzisothiazolin-3-one and salts thereof. A biocide is preferably added in an amount of 0.001 to 3 wt-%, more preferably 0.01 to 1.00 wt-%, each based on the total weight of the pigmented inkjet ink.

Other Components

In the inkjet printing ink, various known additives, for example, polysaccharides, a viscosity adjuster, a film forming agent, a pH adjuster and the like can be suitably selected and used in addition to the components described above, as necessary, according to the object of improving all performances.

Preparation of a Pigmented Inkjet Ink

The pigmented inkjet ink according to the present invention may be prepared by first preparing the pigment dispersion and afterwards dilute the pigment dispersion to the desired pigment concentration and adding all the other ink components, such as adding the water soluble organic solvents needed.

In general it is desirable to make the color ink in the form of a concentrated Aqueous Pigment Dispersion according to the invention, which is subsequently diluted to the appropriate concentration for use in the inkjet printing system. This technique permits preparation of a greater quantity of pigmented ink from the equipment. By dilution, the ink is adjusted to the desired viscosity, color, hue, saturation density, and print area coverage for the particular application. The inkjet inks are prepared by mixing the components with the dispersion using regular mixing devices. A method for the stirring and mixing is not particularly restricted and may be appropriately selected according to necessity, using a homogenizer, a paint shaker, an ultrasonic disperser, a stirrer using ordinary stirring blades, a magnetic stirrer, and a high-speed disperser, for example. The ink is finally filtered before use. With drop sizes less than 20 pL in many cases, and printhead nozzles smaller than 30 microns, a filtration step in the range of 1 to 5 μm is implemented. It is vital to ensure no particulates reach the nozzles, as a single failure can lead to the replacement of an entire printhead at significant cost.

For pigmented inks, multiple-stage filtration is typically used after creation of the dispersion, and again after addition of additives and dilution. Here the main objectives are removal of any oversized or agglomerated pigments from the dispersion, as well as any oversized particles and contaminants from other processes.

The available filter technologies have different applications, advantages and disadvantages. Examples of filter are: membrane, depth and hybrid filter types. Common suppliers of filters for inkjet inks are Pall, Porvair, Membrane Solutions.

In a preferred embodiment, no crosslinking or encapsulation is needed after milling. The stable pigment dispersion according to the invention can be obtained without the need of crosslinking and other additional steps, e.g. filtration step to remove unreacted material, etc. are obsolete. This results in a simpler synthesis process, and is economically more interesting since less energy and resources need to be spent to obtain a stable pigment dispersion.

Optionally, adding a crosslinking and or encapsulation step results in an even more stable dispersion but this process is more complex and more sensitive to unreacted crosslinking agent and/or crosslinked free dispersing agent. This could potential lead to less performant pigment dispersions and corresponding inks when no extra removal step like for example ultrafiltration is used.

### EXPERIMENTAL

Manufacturing Processes

Block Copolymers Synthesis

Block copolymers can be prepared using an array of different, so-called living, polymerization methods. The basis of the method is invariable of the synthetic method used:
An instantaneous initiation, which ensures simultaneously growing of all the polymer chains at a specific propagation speed.
Living polymerization is ensured by adding very small concentrations of active (propagating) chains into the solution at a given time, in order to avoid termination or recombination of radicals.
Continued propagation is strictly controlled, thereby obtaining a small polydispersity of the polymer and thus a well-defined polymer composition.

Further polymerization can be achieved in a number of ways but anionic polymerization and group transfer polymerization (e.g. Atom-Transfer Radical-Polymerization [ATRP], NMP, . . . ) are the two most common synthetic methods. These methods have such specific requirements (no oxygen, no water, . . . ) which make them impractical and expensive when producing large (industrial-sized) volumes of polymers. Two examples thereof are the use of alkyl lithium components at very low temperatures, or naphthanelides to initiate polymerization.

In an exemplary embodiment the block copolymer is prepared by ATRP as described in c“ontrolled living radical polymerization” by Wang and Matyjaszewski (macromolecules 1995, 28 7901-7910).

### Synthesis Examples

The below procedure describes a potential synthesis method to produce the block dispersing agent, which is characterized as AA₃₀-BnA₁₀ having 30 monomers AA for its block length of the matrix stabilization segment and 10 monomers BnA for its block length of the anchoring segment. It is a block copolymer dispersant comprised of two blocks, wherein the matrix stabilization segment is formed by reacting the monomer acrylic acid (AA) and has a length of about 30 repeating units and the anchoring segment is formed by reacting the monomer benzyl acrylate (BnA) and has a length of about 10 repeating units. Other block dispersant architectures can be produced by someone skilled in the art in the same manner by adjusting the amounts and kinds of starting materials and reaction times and the sequence of preparation of the block dispersing agent can be exchanged i.e. first making the BnA block and afterwards the AA block. “Parts” in the description is based on mass unless noted otherwise.

A 250-milliliter triple neck flask equipped with a thermometer, a backflow condenser, and a nitrogen balloon was charged with 0.43 parts of Cu(I)Br, 38.5 parts of tert-butyl acrylate, 41.2 parts of anisole, an internal standard and 0.69 parts of tris[2-(dimethylamino)ethyl]amine (Me6TREN). The mixture was degassed under vacuum and back-filled with nitrogen three times and heated to 60° C. Subsequently, 1.67 parts of methyl 2-bromopropionate (MBP) were added to initiate the polymerization reaction, which was conducted for 0.5 hours.

In a separate flask, 16.2 parts of benzyl acrylate and 0.87 parts of N,N,N′,N″,N″-Pentamethyldiethylenetriamine (PMDETA) were mixed and degassed under vacuum and back-filled with nitrogen three times. This solution was added to the tert-butyl acrylate polymer solution together with 0.72 parts of CuBr and 0.19 parts of Cu(0). The polymerization was stopped after 6 h (Mn=5406 and Mw/Mn=1.37, Conv.=96.4%) by exposing the catalyst to air. The copper catalyst was removed by column chromatography, after which the excess solvent was removed by evaporation.

Subsequently, the tert-butyl acrylate groups of the block copolymer were hydrolyzed. The purified block copolymer was dissolved in 2 volume parts dioxane under reflux, after which 0.5 equivalents of sulfuric acid, compared to the amount of tert-butyl acrylate repeating units of the polymer, were added to the solution. After 2 hours, an equimolar amount of base was added to stop the reaction. The reaction solution was filtrated over Celite® to remove the formed salts. Dioxane was removed by rotary evaporation, to yield the acrylic acid/benzyl acrylate block copolymer.

Another synthesis example to produce the block dispersing agent, which is characterized as AA₁₅-EOEOEA₃₀ having 15 monomers AA for its block length of the matrix stabilization segment and 30 monomers 2-(2ethoxyethoxy)ethyl acrylate (EOEOEA) for its block length of the anchoring segment.

A 250-milliliter triple neck flask equipped with a thermometer, a backflow condenser, and a nitrogen balloon was charged with 1.43 parts of Cu(I)Br, 38.5 parts of tert-butyl acrylate, 41.2 parts of anisole, an internal standard and 1.73 parts of N,N,N′,N″,N″-Pentamethyldiethylenetriamine (PMDETA). The mixture was degassed under vacuum and back-filled with nitrogen three times and heated to 80° C. Subsequently, 3.34 parts of methyl 2-bromopropionate (MBP) were added to initiate the polymerization reaction, which was conducted for 1 h.

In a separate flask, 112.9 parts of 2-(2-ethoxyethoxy)ethyl acrylate, 48.3 parts of anisole and 1.73 parts of PMDETA were mixed and degassed under vacuum and back-filled with nitrogen three times. This solution was added to the tert-butyl acrylate polymer solution together with 0.64 parts of Cu(0). The polymerization was stopped after 4 h (Mn=7165 and Mw/Mn=1.32) by exposing the catalyst to air. The copper catalyst was removed by column chromatography, after which the excess solvent was removed by evaporation.

Subsequently, the tert-butyl acrylate groups of the block copolymer were hydrolyzed. The purified block copolymer was dissolved in 2 volume parts dioxane under reflux, after which 0.5 equivalents of sulfuric acid, compared to the amount of tert-butyl acrylate repeating units of the polymer, were added to the solution. After 2 hours, an equimolar amount of base was added to stop the reaction. The reaction solution was filtrated over Celite® to remove the formed salts. Dioxane was removed by rotary evaporation, to yield the acrylic acid/2-(2-ethoxyethoxy)ethyl acrylate block copolymer. The current synthesis method describes the “common” reactor-based synthesis. Alternatively, a Flow chemistry process can be employed to synthesize the mentioned block dispersing agents. The inventors refer to “Flow Chemistry: Integrated Approaches for Practical Applications”, Santiago V Luis, Eduardo Garcia-Verdugo (Ed.), 2019, (ISBN: 978-1-78801-498-4/978-1-78801-609-4). The block dispersant was synthesized using a flow reactor using the same starting materials as the “common reactor” except EBiB was used as an initiator, 365 nm UV LED light as a source of photons, the reaction was initiated by reduction of Cu(II)Br₂ to Cu(0) and the solvents used were acetonitrile:ethanol 1:1. The flow reactor was assembled with PFA tubing ( 1/16″ OD, 0.75 mm ID). The streams were respectively connected via inline check valves, T-piece and a static mixer before entering the photoreactor to ensure homogeneity. 16 LEDs (365 nm) were assembled on the octagonal reactor (in house built using 3D printer, with a PLA filament). The second polymer block can be added to the first block in a subsequent reactor module. Finally, hydrolysation and filtration steps can be performed similar to the batch process described above or integrated in the flow reactor setup.

In order to make the dispersant compatible with the carrier, the hydrophilic monomer needs to be neutralized thereby ionizing the salt-forming group of the block copolymer. As the neutralizing agent, there can be used an acid or a base depending upon the kinds of the salt-forming group, e.g. basic such as DMAEMA or acidic such as (meth)acrylic acid. The neutralizing agent for basic monomers includes, for instance, inorganic acids such as hydrochloric acid and sulfuric acid; and organic acids such as acetic acid, propionic acid, lactic acid, succinic acid and glycolic acid. In addition, the neutralizing agent for acidic monomers includes, for instance, tertiary amines such as trimethylamine and triethylamine, triethanolamine, ammonia, 2-dimethylamino ethanol, 2 anmino-2 methyl 1 propanol, 2 (2amino-ethylamino) ethanol, 2 amino-2methyl 1 propanol, sodium hydroxide, potassium hydroxide, and the like. The present invention is not limited to those exemplified ones.

Note that the total dispersant weight mentioned in the examples below includes the mass of the neutralizing agent.

Water Solubility of Block Copolymer Dispersants

Examples of solubilization are listed in Table 1. Test of water solubility is carried out according to the test procedure described further below.

TABLE 1

| | | | | | weight % in water |
|---|---|---|---|---|---|
| | neutralisation | | Dissolution conditions | | solubilized, stable at |
| polymer | agent | matrix | time | temperature | 25° C. for 1 week (*) |
| AA₃₀-BnA₁₀ | MEA | distilled H2O | 4 h | 60° C. | 20% |
| AA₁₅-EOEOEA₃₀ | MEA | distilled H2O | 6 h | 25° C. | 25% |
| BnA₄₀-AA₂₅ | MEA | distilled H2O | 12 h | 60° C. | 16% |

Dissolution was carried out in round flask using mechanical stirring. (*) stability is checked by decanting aqueous polymer solution and checking for solid sedimentation.

Note that ratio hydrophilic/hydrofobic balance is very low for polymer dispersant BnA₄₀-AA₂₅, but is still soluble for longer duration in absence of organic co-solvent at high concentration in water.

Encapsulation

Optionally, crosslinking is performed right after the milling process by chemically coupling the dispersing agents together on the surface. A very popular method to achieve this sees an epoxy compound (mostly di- or tri-epoxides) added to the dispersion in order to couple a certain portion of the (meth)acrylic acid monomers present in the dispersing agent backbone (preferably on the surface of the pigment particle). If not all dispersant is adhered to the pigment surface then these free polymers will disturb the crosslinking process e.g. by being built in between polymer particles and thus flocculating part of the dispersion and therefore have to be removed afterwards. These resulting encapsulated pigment particles will possess great stability because of the formation of a “net” or “capsule” of dispersing agent across the surface of the particle, which cannot be disturbed by the addition of co-solvents and surfactants.

Pigment Dispersion Production

A pigment dispersion having a composition according to Table 2 is prepared by milling 30 g of raw materials in a ball jar with a pigment concentration of 15%.

The ball jar milling is performed in PP bottles of 125 mL with a diameter of 45 mm. The bottles are filled with 200 g of 0.3 mm YTZ ceramic beads from Tosoh. The milling is done at a rotational speed of 36 m/min for 7 days.

TABLE 2
Pigment dispersion composition

| component | weight | |
|---|---|---|
| Pigment (according table 2) | 4.5 | g |
| Block dispersant | 4.5 | g |
| (according table 2), | | |
| neutralized with | | |
| sodium hydroxide | | |
| water | 21 | g |
| Total | 30 | g |

Analytical Methods

Particle Size Analysis

The particle size of pigments is determined on a Nicomp 3.80 particle sizer (Particle sizing systems, Santa Barbara California USA). The dispersion is diluted to 10 to 100 ppm to reach optimal measurement performance (i.e. the dispersion is diluted 10*10⁶ times to 100*10⁶ times). The diluted samples are measured at 23° C. with a HeNe laser and the dv50 is obtained from the Gaussian analysis of the scattered light intensity profile.

Surface Tension

The surface tension is a value measured at a temperature between 23° C. and 26° C. by the air bubble pressure method using a surface tensiometer SITA Pro Line T15 (SITA Messtechnik Co, Dresden GE.). The bubble lifetime used is 10 seconds and this is the time between the generation of a new air-liquid interface (at the tip of a capillary immersed into the ink liquid) until the maximum bubble pressure is reached. The maximum pressure measured is automatically recalculated into a surface tension value of the liquid (in mN/m) after calibration of the device in distilled water.

Viscosity

The viscosity of (dispersion and supernatant liquid) is measured with a Haake Rheostress RS6000 operated in shear rate sweep from 0.1 to 3000 1/s at 25° C. and expressed in mPa·s. The instrument is equipped with a cone/plate geometry type C60/1° and the gap is set to 0.052 mm. The reported viscosity is measured at a frequency of 3000 1/s.

Water Solubility of the Block Copolymer Dispersant

A block copolymer is defined as “water soluble” when the block copolymer remains in solution in water at 25° C. with at least 15 wt. % of dry polymer in water during at least a week, preferably remains in solution in water at 25° C. for at least one or more months, more preferably the weight percentage of dissolved dry polymer in water at 25° C. is at least 20 wt. % during at least a week and most preferably the weight percentage of dissolved dry polymer in water at 25° C. is at least 25 wt. % during at least a week. The polymer dispersant solution is obtained by mixing the dried block copolymer with 100 g distilled water for at least 2 hours at a temperature of at least 25° C. Stirring and/or increasing the temperature up to 60° C. may be used to accelerate the dissolution process. The time of mixing may be selected between 2 hours and 12 hours.

In case where the dry block copolymer contains acidic repeating units in the matrix stabilization segment, the “water soluble” test conditions are carried out by neutralizing all acidic functions by adding monoethanol amine (MEA) base to water such that the pH of the polymer solution is 8.5 or above. In case where the dry block copolymer contains basic functionality in the repeating units of the matrix stabilization segment, the “water soluble” state test conditions are carried out by neutralizing all basic functions by adding HCl to water such that the pH of the polymer solution is 5.5 or below.

Assessment Methodology

Stability of Dispersions

The dispersion stability of the pigment dispersion was tested in very harsh conditions. The dispersions were stored at elevated temperature of 80° C. for 7 days after having added diethyleneglycolmonobytulether (DEGMBE) as an organic solvent for disturbing the pigment dispersion stability.

A closed glass vial with 5 g of dispersion, 1.5 g of DEGMBE and 8.5 g of water was used. The pigment dispersion has 15 wt-% pigment relative to the total weight of the pigment dispersion. The amount of pigment in the test is 15 wt-%×5 [g]/15 [g]=5 wt-% relative to the total weight of the composition. The amount of DEGMBE is 1.5/15=10 wt-% relative to the total weight of the composition. Particle size is measured before and after the heat treatment. The stability is considered good when the dv50 after the heat treatment is smaller than 1.10 times the dv50 before the heat treatment.

Grinding Performance of Dispersing Agents

Grinding performance of dispersing agents is determined by the particle size that can be obtained after grinding. Good grinding performance is reached dv50<175 nm. When the grinding performance is not within specification no stability test was performed.

The Hansen Solubility Parameters

The Hansen Solubility parameters according to the invention are calculated according to Y-MB methodology using HSPiP software version 5.2.03 and expressed in cal^{1/2} cm^{-3/2}.

Examples of the Hansen Solubility parameters of repeating units R1 and R2 are shown in Table 3.1 and 3.2.

TABLE 3.1
Examples of less hydrophobic repeating units R1

| | Repeating unit R1 (without vinyl | | | δ(polar + |
|---|---|---|---|---|
| Monomer name | bond) [in SMILES notation] | δ(polar) | δ(hydrogen) | hydrogen) |
| methylpolypropylene | COCCCOCCCOCCCOCCCOCCCOC(═O)CC | 6.4 | 5.2 | 8.2 |
| acrylate | | | | |
| methylpolyglycol | COCCOCCOCCOCCOCCOC(═O)CC | 5.4 | 7.4 | 9.2 |
| acrylate | | | | |
| Vinyl methyl | CC1CN(C(═O)O1)CC | 8.9 | 6.8 | 11.2 |
| oxazolidinone | | | | |
| phenoxyethyl | CCC(═O)OCCOC1═CC═CC═C1 | 5.2 | 6.2 | 8.1 |
| methacrylate | | | | |
| N-,N-diethylacrylamide | CCN(CC)C(═O)CC | 8.8 | 3.6 | 9.5 |
| Ethoxyethoxy ethyl | CCOCCOCCOC(═O)CC | 5.4 | 6.6 | 8.5 |
| acrylate | | | | |
| 4-Acryloylmorpholine | CCC(═O)N1CCOCC1 | 11.3 | 5.9 | 12.7 |
| 2-vinylpyrollidone | CCN1CCCC1═O | 8.5 | 6.5 | 10.7 |
| Hydroxyethylacrylate | CCC(═O)OCCO | 8.2 | 13.2 | 15.5 |
| Hydroxybutylacrylate | CCC(═O)OCCCCO | 6.8 | 11 | 12.9 |
| Hydroxy styrene | CCC1═CC═C(C═C1)O | 5.3 | 9.8 | 11.1 |
| DMAEMA | CN(C)CCOC(═O)CC | 4.5 | 5.9 | 7.4 |
| 2-[[(Butylamino)carbonyl]oxy]ethyl | CCCCNC(═O)OCCOC(═O)CC | 8.1 | 7.8 | 11.25 |
| acrylate | | | | |
| minimum | | 4.5 | 3.6 | 7.4 |

Table 3.1 shows the polar bonding value δ(polar) of R1 and the hydrogen bonding value δ(hydrogen) of R1 and the Hansen Solubility Parameter value δ(polar+hydrogen)_{R1}, being the sum of the polar bonding value of R1 and the hydrogen bonding value of R1. The values are expressed in [cal^{1/2} cm^{-3/2}]

TABLE 3.2
Examples of hydrophobic repeating units R2

| Monomer | Repeating unit R2 (without vinyl | | | δ(polar + |
|---|---|---|---|---|
| name | bond) [in SMILES notation] | δ(polar) | δ(hydrogen) | hydrogen) |
| biphenyl | CCC(═O)OC1═CC═CC═C1C2═CC═CC═C2 | 3.3 | 4.3 | 5.4 |
| acrylate | | | | |
| stearylacrylate | CCCCCCCCCCCCCCCCCCCCCCCCCCOC(═O)C═ | 1.5 | 2 | 2.5 |
| benzylacrylate | CCC(═O)OCC1═CC═CC═C1 | 4 | 5.5 | 6.8 |
| ethylhexyl | CCCCC(CC)COC(═O)CC | 3 | 4.1 | 5.1 |
| acrylate | | | | |
| isodecyl | CC(C)CCCCCCCOC(═O)CC | 2.8 | 3.3 | 4.3 |
| acrylate | | | | |
| styrene | CCC1═CC═CC═C1 | 2.3 | 3 | 3.8 |
| cyclohexyl | CCC(═O)OC1CCCCC1 | 3.7 | 4.9 | 6.1 |
| acrylate | | | | |
| n-butyl | CCCCOC(═O)CC | 4.3 | 5.6 | 7.1 |
| acrylate | | | | |
| phenylacrylate | CCC(═O)OC1═CC═CC═C1 | 4.3 | 5.7 | 7.1 |
| maximum | | 4.3 | 5.7 | 7.1 |

Table 3.2 shows the polar bonding value δ(polar) of R2 and the hydrogen bonding value δ(hydrogen) of R2 and the Hansen Solubility Parameter value δ(polar+hydrogen)_{R2}, being the sum of the polar bonding value of R2 and the hydrogen bonding value of R2. The values are expressed in [cal^{1/2} cm^{-3/2}].

The sum of the polar bonding value of a repeating unit and the hydrogen bonding value of repeating unit is defined as the square root of the sum of the square of the polar bonding value of the repeating unit and the square of the hydrogen bonding value of the repeating unit: δ(polar+hydrogen)=[δ(polar)²+δ(hydrogen)²].

Results

Several block copolymeric dispersants were prepared according to Table 4:

TABLE 4
composition of exemplary block copolymeric dispersants

| Dispersant | | | |
|---|---|---|---|
| # | Type | Chemical Formula | Description |
| DA1 | A | NaA₁₅-BnA₃₀ | matrix stabilization segment of sodium salt of acrylic |
| | | | acid of 15 repeating units and anchoring segment of 30 |
| | | | repeating units of benzylacrylate |
| DA2 | B | EOEOEA₃₀-NaA₂₅ | matrix stabilization segment of sodium salt of acrylic |
| | | | acid of 25 repeating units and anchoring segment of 30 |
| | | | repeating units of 2-(2-Ethoxyethoxy)ethyl acrylate |
| DA3 | A | NaA₂₅-BnA₄₀ | matrix stabilization segment of sodium salt of acrylic |
| | | | acid of 25 repeating units and anchoring segment of 40 |
| | | | repeating units of benzylacrylate |
| DA4 | B | EOEOEA₃₀-NaA₁₄ | matrix stabilization segment of sodium salt of acrylic |
| | | | acid of 14 repeating units and anchoring segment of 30 |
| | | | repeating units of 2-(2-Ethoxyethoxy)ethyl acrylate |

Different pigment dispersion were prepared (Table 5) using the block copolymeric dispersants mentioned in Table 4 according to the composition mentioned in table 2. The pigment dispersions contained 15 wt % dispersant and the pigment/total dispersant weight ratio is 1, resulting in 30 wt % pigment plus dispersant in the pigment dispersion. The pigment dispersions contained water as aqueous carrier during the grinding experiments and no water soluble organic solvents.

TABLE 5
evaluation pigment stability of several pigment dispersions

| | | | | | Dispersant/ | | PSD | | | Heat |
|---|---|---|---|---|---|---|---|---|---|---|
| | | | Dispersant | | Pigment ratio | | [dv50] | | | treatment |
| Example | | Pigment | # | | [wt/wt] | | after | Heat | Grinding | stability |
| # | inv/comp | [color] | A | B | A | B | milling | treatment | [evaluation] | [evaluation] |
| 1 | inv | c | DA1 | DA2 | 0.5 | 0.5 | 143 | 120 | V | V |
| 2 | inv | m | DA3 | DA2 | 0.5 | 0.5 | 127 | 134 | V | V |
| 3 | inv | m | DA3 | DA4 | 0.5 | 0.5 | 105 | 104 | V | V |
| 4 | inv | m | DA3 | DA4 | 0.25 | 0.25 | 123 | 104 | V | V |
| 5 | inv | k | DA3 | DA2 | 0.75 | 0.75 | 122 | 139 | V | V |
| 6 | comp | c | DA1 | | 1 | | 185 | 105 | X | V |
| 7 | comp | m | DA3 | | 1 | | 192 | 116 | X | V |
| 8 | comp | k | DA3 | | 1 | | 233 | 195 | X | V |
| 9 | comp | m | | DA2 | | 1 | 124 | 211 | V | X |
| 10 | comp | m | | DA4 | | 1 | 113 | 244 | V | X |
| 11 | comp | k | | DA2 | | 1 | 126 | 760 | V | X |

Notes:
Pigment selection:
c: PB15:3 from Clariant: PV Fast Blue BG
m: PR122 from Clariant: Inkjet Magenta E02
k: PBk7 from Omsk grade N220FA
Evaluation stability:
V: Ok
X: not Ok

Grinding performance was considered OK (V) when the dv50<175 nm. The heat treatment stability is considered good when the dv50 after the heat treatment is smaller than 1.10 times the dv50 before the heat treatment.

From the examples in Table 3 it can be concluded that extremely stable pigment dispersions can be obtained for the pigment dispersions 1-5 having a block copolymeric dispersant of type A and a block copolymeric dispersant of type B.

Equivalent good grinding results and stability results are obtained as shown in Table (5) for Example 1-5 using any one or more dispersants DA1-DA4 which are neutralized with triethanol amine or with monoethanol amine instead of using a sodium salt. Thereby it is demonstrated that the advantageous properties of these dispersants do not depend on the type of counter ion. With the pigment dispersions of examples 1 to 5 inkjet inks were prepared according to Table 6.

TABLE 6
inkjet ink compositions

| | ink 1 | ink 2 | ink 3 | ink 4 | ink 5 | ink 6 |
|---|---|---|---|---|---|---|
| pigment dispersion | ex 1 | ex 2 | ex 3 | ex 4 | ex 5 | ex 1 |
| Concentration | 20 | 40 | 40 | 40 | 35 | 20 |
| pigment dispersion | | | | | | |
| [wt-%] | | | | | | |
| Glycerol | 20 | 18 | 18 | 18 | 18 | 18 |
| 1-2 propanediol | 10 | 9 | 9 | 9 | 9 | 9 |
| diethylenglycol | 3 | 3 | 3 | 3 | 3 | 3 |
| monobutylether | | | | | | |
| surfynol 465 | 0.9 | 0.9 | 0.9 | 0.9 | 0.9 | 0.9 |
| dynol 960 | 1.8 | 1.8 | 1.8 | 1.8 | 1.8 | 1.8 |
| joncryl J8050E | 0 | 0 | 0 | 0 | 0 | 7.5 |
| nuosept 22 | 0.003 | 0.003 | 0.003 | 0.003 | 0.003 | 0.003 |
| water | balance | balance | balance | balance | balance | balance |

All the inks have a viscosity between 4-7 mPa·s and a surface tension measured with a Sita bubble tensiometer after 10 see between 20 and 27 mN/m.

With these inks 1-6 an excellent jet quality and image quality was observed using a KJ4B AQ printhead from Kyocera at a printing speed of 1 m/s on coated and uncoated paper substrates. Example 6 demonstrates that when using a binder resin (Joncryl J8050E) the inkjet ink remains stable. The binder resin Joncryl J8050E improves the adhesion of the pigment to various paper and filmic substrates.

1. An inkjet ink for forming an image on a substrate, the inkjet ink comprising:
a pigment P,
a first block copolymer dispersant D1 for dispersing the pigment P,
a second block copolymer dispersant D2 for dispersing the pigment P, and
an aqueous carrier;
wherein said first block copolymer dispersant D1 is different from said second block copolymer dispersant D2, wherein each block copolymer dispersant D1, D2 comprises an anchoring segment A1, A2 for anchoring to the pigment P,
wherein each of the block copolymer dispersant D1, D2 additionally comprises a matrix stabilization segment M for aqueous phase stabilization of the pigment P,
wherein the anchoring segment A1 of the first block copolymer dispersant D1 comprises a repeating unit R1 and the anchoring segment A2 of the second block copolymer dispersant D2 comprises a repeating unit R2, and
wherein the repeating unit R1 is less hydrophobic than the repeating unit R2.

2. The ink according to claim 1, wherein the repeating unit R1 has a Hansen Solubility Parameter value δ(polar+hydrogen)_{R1}, wherein δ(polar+hydrogen)_{R1}>7.2 cal^{1/2} cm^{-3/2}, wherein the Hansen Solubility Parameter value δ(polar+hydrogen) is defined as √[δ(polar)²+δ(hydrogen)²], preferably wherein the polar bonding value of R1: δ(polar)_{R1}>4.4 cal^{1/2} cm^{-3/}.

3. The ink according to claim 1, wherein the repeating unit R1 is a non-ionic repeating unit.

4. The ink according to claim 1, wherein the repeating unit R2 has a Hansen Solubility Parameter value δ(polar+hydrogen)_{R2}, wherein δ(polar+hydrogen)_{R2}<7.2 cal^{1/2} cm^{-3/2}, wherein the Hansen Solubility Parameter value δ(polar+hydrogen) is defined as √[δ(polar)²+δ(hydrogen)²], and preferably wherein the polar bonding value of R2 δ(polar)_{R2}<4.4 cal^{1/2} cm^{-3/}.

5-6. (canceled)

7. The ink according to claim 1, wherein the anchoring segment A1 of the first block copolymer dispersant D1 has another repeating unit R1′ different from R1, and wherein the other repeating unit R1′ preferably has a Hansen Solubility Parameter value δ(polar+hydrogen)_{R1}>7.2 cal^{1/2} cm^{-3/2}; and/or
wherein the anchoring segment A2 of the second block copolymer dispersant D2 has another repeating unit R2′ different from R2, and
wherein the other repeating unit R2′ preferably has a Hansen Solubility Parameter value δ(polar+hydrogen)_{R2}<7.2 cal^{1/2} cm^{-3/2}.

8. The ink according to claim 1, wherein the anchoring segment A1 is formed using at least one monomer Mn₁, and
the anchoring segment A2 is formed using at least one monomer Mn₂,
wherein the monomer M₁, M₂ is selected from the group consisting of a methacrylate, an acrylate, and vinyl monomers, and
wherein preferably the monomer Mn2 of the anchoring segment A2 comprises an alkyl, alkenyl or aryl group.

9. (canceled)

10. The ink according to claim 8, wherein the monomer Mn₂ of the anchoring segment A2 is at least one of benzyl methacrylate, butyl methacrylate, methyl methacrylate, ethyl methacrylate, propyl methacrylate, hexyl methacrylate, 2-ethylhexyl methacrylate, octyl methacrylate, lauryl methacrylate, stearyl methacrylate, p-tolyl methacrylate, sorbyl methacrylate, cyclohexyl methacrylate, benzyl acrylate, butyl acrylate, methyl acrylate, ethyl acrylate, propyl acrylate, hexyl acrylate, 2-ethylhexyl acrylate, octyl acrylate, lauryl acrylate, stearyl acrylate, p-tolyl acrylate, sorbyl acrylate, cyclohexyl acrylate, and any mixture thereof and/or
wherein the monomer Mn₁ of the anchoring segment A1 is at least one of tri(ethylene glycol) methyl ether acrylate, hydroxyethyl acrylate, hydroxypropyl acrylate, dimethylaminoethyl acrylate (DMAA), N,N-dimethylacrylamide, acryloyl morpholine (ACMO), N-vinylpyrrolidone (NVP), vinyl methyl oxazolidinone (VMOX), and 2-(2ethoxyethoxy)ethyl acrylate (EOEOEA), phenoxyethyl methacrylate, methacrylonitrile, ethylene glycol methyl ether methacrylate, 2-ethoxyethyl methacrylate, di(ethylene glycol) methyl ether methacrylate, tri(ethylene glycol) methyl ether methacrylate, hydroxyethyl methacrylate, hydroxypropyl methacrylate, di(propylene glycol) methyl ether methacrylate, phenoxyethyl acrylate, ethylene glycol methyl ether acrylate, 2-ethoxyethyl acrylate, di(ethylene glycol) methyl ether acrylate, 2-[[(butylamino)carbonyl]oxy]ethyl acrylate, and any mixture thereof.

11. (canceled)

12. The ink according to claim 10, wherein the monomer Mn₁ of the anchoring segment A1 is an acrylate or methacrylate and comprises an monoethyleneglycol group or polyethyleneglycol group.

13. The ink according to claim 1, wherein the matrix stabilization segment M is formed using at least one monomer Mn₃ for obtaining an ionic hydrophilic repeating unit for aqueous phase stabilization of the pigment, the ionic hydrophilic repeating unit optionally containing a neutralized acid group, neutralized basic group or other ionic functionalities such as a quaternary ammonium group.

14. The ink according to claim 1, wherein the matrix stabilization segment M is formed using at least one monomer Mn₃ which is selected from the group consisting of methacrylic acid, acrylic acid, maleic acid, maleic acid monoester, itaconic acid, itaconic acid monoester, crotonic acid, crotonic acid monoester, N,N-dimethylaminoethyl methacrylate, N,N-diethylaminoethyl methacrylate, N,N-dimethylaminoethyl acrylate, N,N-diethylaminoethyl acrylate, t-butylaminoethyl methacrylate, t-butylaminoethyl acrylate, and mixtures thereof.

15. The ink according to claim 1, wherein the matrix stabilization segment M comprises at least one repeating unit R3, which comprises an ionic moiety.

16. The ink according to claim 1, wherein the repeating units R1, R2 of the anchoring segment A1, A2 do not have an ionic group.

17. The ink according to claim 1, wherein the anchoring segment A1 has a number of repeating units n and wherein the repeating units R1 are at least 50 number-% of the total number of repeating units n1, preferably at least 80 number-% of the total number of repeating units n1; and/or
wherein the anchoring segment A2 has a number of repeating units n and wherein the repeating units R2 are at least 50 number-% of the total number of repeating units n2, preferably at least 80 number-% of the total number of repeating units n2.

18. The ink according to claim 1, wherein the weight ratio between the block copolymer dispersant D1 and the block copolymer dispersant D2 is between 0.1 and 10, preferably between 0.2 and 5.

19. The ink according to claim 1, wherein the weight ratio between the pigment P and the sum of the block copolymer dispersant D1 and the block copolymer dispersant D2 is between 0.2 and 10.0, preferably between 0.4 and 5.0.

20. The ink according to claim 1, wherein the weight ratio between the pigment P and the block copolymer dispersant D1 is between 0.05 and 10.0, preferably between 0.1 and 5.0.

21. The ink according to claim 1, wherein the weight ratio between the pigment P and the block copolymer dispersant D2 is between 0.05 and 10.0, preferably between 0.1 and 5.0.

22. The ink according to claim 1, wherein the block copolymer dispersant D1 and/or the block copolymer dispersant D2 is a diblock copolymer.

23. Pigment dispersion for forming an inkjet ink, the pigment dispersion comprising a pigment P, a first block copolymer dispersant D1 for dispersing the pigment P and a second block copolymer dispersant D2 for dispersing the pigment P, and an aqueous carrier; wherein said first block copolymer dispersant D1 is different from said second block copolymer dispersant D2, wherein each block copolymer dispersant D1, D2 comprises an anchoring segment A1, A2 for anchoring to the pigment P, wherein each of the block copolymer dispersant D1, D2 additionally comprises a matrix stabilization segment M for aqueous phase stabilization of the pigment P, wherein the anchoring segment A1 of the first block copolymer dispersant D1 comprises a repeating unit R1 and the anchoring segment A2 of the second block copolymer dispersant D2 comprises a repeating unit R2, wherein the repeating unit R1 is less hydrophobic than the repeating unit R2;
wherein the aqueous carrier contains water, and optionally a total amount of water soluble organic solvent, which is less than 20 wt %, preferably less than 2 wt %, of the total weight of the aqueous carrier, and
wherein the repeating unit R1 has a Hansen Solubility Parameter value δ(polar+hydrogen)_{R1} (=√[δ(polar)²+δ(hydrogen)²]), wherein δ(polar+hydrogen)_{R1}>7.2 cal^{1/2} cm^{-3/2}.

24. (canceled)

25. Pigment dispersion according to claim 23, wherein the amount of pigment P in the pigment dispersion is in the range of 10-80 wt-% based on weight of the pigment dispersion.

26-29. (canceled)

30. An inkjet ink for forming an image on a substrate, the inkjet ink comprising:
a pigment P,
a first block copolymer dispersant D1 for dispersing the pigment P,
a second block copolymer dispersant D2 for dispersing the pigment P, and
an aqueous carrier; wherein said first block copolymer dispersant D1 is different from said second block copolymer dispersant D2, wherein each block copolymer dispersant D1, D2 comprises an anchoring segment A1, A2 for anchoring to the pigment P,
wherein each of the block copolymer dispersant D1, D2 additionally comprises:
a matrix stabilization segment M for aqueous phase stabilization of the pigment P, wherein the anchoring segment A1 of the first block copolymer dispersant D1 comprises a repeating unit R1 and the anchoring segment A2 of the second block copolymer dispersant D2 comprises a repeating unit R2, wherein the repeating unit R1 is less hydrophobic than the repeating unit R2;
wherein dispersant D1 and/or dispersant D2 is a diblock copolymer; and
wherein the copolymers each have an Mw of 2000 to 20000 g/mol more preferably between 3000 to 12000 g/mol, wherein the ratio between the total number of repeating units of anchoring segment A to the total number of repeating units of matrix stabilizing segment M of D1 and D2 is in the range of 1 to 5.
